(19) United States
(12) Patent Application Publication
(10) Pub. No.: US 2011/0078024 A1
(43) Pub. Date: Mar. 31, 2011

(54) SYSTEM AND METHOD FOR PROVISIONING ADVERTISEMENTS TO A VEHICLE USER

(75) Inventors: Daniel John Messier, Albany, NY (US); Roman Brusilovsky, Clifton Park, NY (US); John William Carbone, Ballston Spa, NY (US); Joseph James Salvo, Schenectady, NY (US)

(73) Assignee: GENERAL ELECTRIC COMPANY, Schenectady, NY (US)

(21) Appl. No.: 12/568,921

(22) Filed: Sep. 29, 2009

(51) Int. Cl. G06Q 30/00

(52) U.S. Cl. 705/14.63; 705/14.62

(57) ABSTRACT

A method for provisioning of advertisement to a user of a vehicle is provided. The method comprises determining information comprising attributes associated with behavior of the user, analyzing the information of the user and communicating at least one advertisement to the user wherein the at least one advertisement is based on the analyzed information.

### BACKGROUND

The invention relates generally to advertising management and, more particularly, to a system and method for provisioning advertisements to a vehicle user.

Various modes of advertising used today include print, radio, television, advertising consoles, the Internet, among several others. Several targeted advertising techniques enhance the effectiveness of the advertising by matching advertisements with one or more attributes of a potential targeted viewer of the advertisements.

According to one conventional method, internet advertisements are shown to users based on the user's IP address, which provides an approximation about the physical location of the user. In other cases, a user's profile or browsing history is used for showing advertisements to the user.

According to another method, advertisements are provisioned on an audio visual display console in a vehicle based on the location of the vehicle and/or based on expected passenger profile for the vehicle.

While some variants of targeted advertising exist on all modes of advertising, the effectiveness of such targeted advertising, and hence the relevance of advertisements shown to viewers of the advertisements, is variable, and generally low. Therefore, a need exists for improved advertisement provisioning systems and methods that may address one or more of the problems set forth above.

### BRIEF DESCRIPTION

In accordance with one aspect of the invention, a method for provisioning of advertisement to a user of a vehicle is provided. The method comprises determining information comprising attributes associated with behavior of the user, analyzing the information of the user and communicating at least one advertisement to the user wherein the at least one advertisement is based on the analyzed information.

In accordance with another aspect of the invention, an apparatus for provisioning of advertisements to a user of a vehicle is provided. The apparatus includes a telematics device to determine information comprising attributes associated with behavior of the user of the vehicle, a monitor module configured to analyze the information of the user of the vehicle and an advertising module to communicate at least one advertisement to the user wherein the at least one advertisement is associated with the behavior.

In accordance with yet another aspect of the invention, a system for provisioning of advertisements to a user of a vehicle is provided. The system includes a vehicle telematics device to determine information comprising attributes associated with behavior of the user of the vehicle, an agent for aggregating the information and a server comprising a classification module for classifying the user behavior and an advertising module for provisioning of at least one advertisements to the vehicle, the at least one advertisement being provisioned based on the classification of user behavior.

In accordance with yet another aspect of the invention, a method of retrofitting a vehicle for provisioning of advertisements to a user of the vehicle is provided. The method includes providing a telematics device in the vehicle, the telematics device configured to generate and/or determine information comprising attributes associated with behavior of the user of the vehicle and providing an agent in the vehicle, the agent configured to aggregate the information comprising the attributes associated with the user behavior.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram representation of an exemplary advertisement provisioning system according to an embodiment of the invention.

FIG. 2 is a block diagram representation of an exemplary vehicle, according to an embodiment of the invention.

FIG. 3 is a block diagram representation of an exemplary server, according to an embodiment of the invention.

FIG. 4 is a block diagram representation of an exemplary storage system, according to an embodiment of the invention.

FIG. 5 is a flow diagram of a method for provisioning of advertisements to a vehicle user according to an embodiment of the invention.

### DETAILED DESCRIPTION

As explained in detail further below, various embodiments of the present disclosure enable provisioning of advertisements to a user in a vehicle. The user includes a driver or a passenger in the vehicle. According to some embodiments, an agent is configured to aggregate data associated with user (e.g. driver of the vehicle) behavior, location of the vehicle, and context data of the vehicle. The information is communicated to a server for further processing, or in some embodiments, the information may be at least partially processed on board the vehicle. The information is analyzed to determine several possibilities pertaining to the vehicle location, vehicle context and user behavior. Based on the analyzed information, advertising module accesses and provisions advertisements to the user, for example, on devices in the vehicle, or a device (e.g. mobile phone) associated with the user.

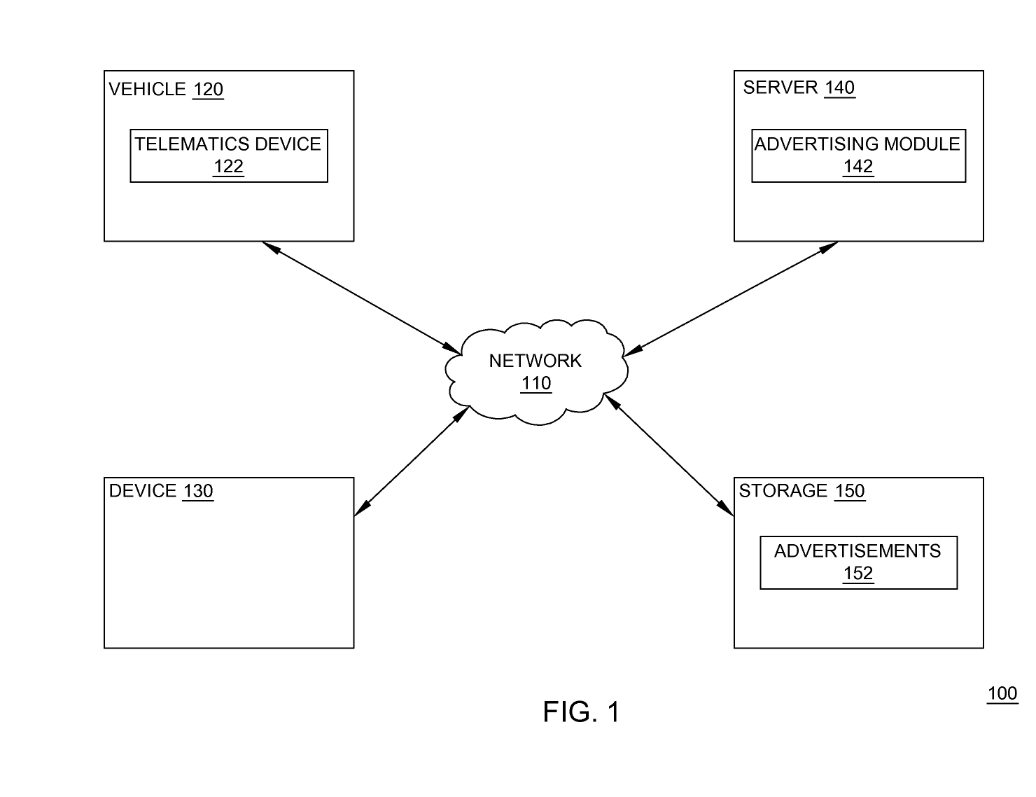

In an illustrated embodiment of the invention as shown in FIG. 1, a block diagram representation of a system 100 for provisioning of advertisements is depicted. The system 100 comprises a network 110, a vehicle 120 comprising a telematics device 122, a device 130 associated with a user of the vehicle 120, a server 140 comprising an advertising module 142, and storage system 150 comprising one or more advertisements 152.

The network 110 comprises a communication system that connects computing devices (e.g. computers) and communication devices (e.g. mobile phones, PSTN phones, internet devices) by wire, cable, fiber optic and/or wireless link facilitated by various types of well-known network elements, such as hubs, switches, routers, telecommunications antennae, towers, satellite(s) and the like. The network 110 may employ various well-known protocols to communicate information among the network resources. For example, the network 110 may be a part of a communications network, for example, the Internet or Intranet using various communications infrastructure such as Ethernet, WiFi, WiMax, General Packet Radio Service (GPRS), and/or a telecommunications network such as GSM, CDMA, PSTN networks, and the like.

The vehicle 120 is a means of transport, for example, a car, a truck, a lorry and/or the like. The vehicle 120 includes various components (e.g., a steering, an engine, a controller, bearings, shafts, shock absorbers, tyres and/or the like) that facilitate normal vehicle operation. The vehicle 120 further includes the telematics device 122, configured to monitor, aggregate, send and/or receive information to and from the vehicle 120. The telematics device 122 is also configured to display the information in the vehicle 120. The telematics device 122 is configured for several operations, for example, including determining a location of the vehicle 120 (e.g. using a GPS system and/or other solutions for determining vehicle location), aggregating and communicating vehicle information including information such as tyre pressure, oil pressure among others, and user/driver information, such as wheel angle response, honking frequency, iris profile of the user/driver among several others. In the illustrated embodiment, the telematics device 122 is configured to cooperate with an on board diagnostic agent configured to process the vehicle information at least partially. In this embodiment, the telematics device 122 communicates the at least partially processed information to the server 140.

The device 130 is a general communications device (e.g., a mobile phone, a PDA, a cell phone, a pager, a laptop, a desktop, a terminal and/or the like) known to one of ordinary skill in the art having the benefit of this disclosure. The device 130, which is associated with the user of the vehicle 120, is generally usable to send and receive communication via a voice call, a text message, a multimedia message, an email and/or the like, with other elements on the network 110. Further, a location of the device 130 may be determined based on its connectivity within the network 110, and therefore, the location of the user may be determined. Alternately, those skilled in the art will readily appreciate that location of the device (and the user) may be determined using GPS and/or other location determination techniques generally known in the art, and all such techniques are included within the scope and spirit of the present invention.

The server 140 is a computing device (e.g., a laptop, a desktop and/or the like) known to one of ordinary skill in the art having the benefit of this disclosure. The server 140 generally provides various services (e.g., application services, storage services and/or the like) to the vehicle 120 and the device 130 within the system 100. The server 140 is further configured to process information communicated by the telematics device 122. Such information may be utilized, for example, for routine tracking of the vehicle location and operating condition (e.g. fuel levels, brake fluid level, oil change etc.) of the vehicle 120, status of components on the vehicle 120 (e.g. a refrigerator installed on a perishable goods transport vehicle etc.), routing information of the vehicle, and provisioning of advertisements as discussed further below, among other purposes.

The server 140 includes an advertising module 142 among various other software packages. According to some embodiments, the advertising module 142 facilitates the provisioning of one or more advertisements to the vehicle 120 or to the device 130 associated with the user of the vehicle 120. For example, if any of the vehicle's 120 components malfunction, the server 140 is configured to communicate advertisements of repair shops that are in proximity to the vehicle 120. In certain embodiments, the server 140 may also provide rerouting schedule for the vehicle 120 to reach the repair shop. In one or more embodiments, the advertising module 142 includes software code (e.g., processor executable instructions) configured to communicate advertisements to the vehicle 120. The server 140 analyzes the information communicated by the telematics device 122. Based on the analysis, the advertising module 142 identifies suitable advertisements (e.g. advertisements 152) that are then provisioned to the vehicle 120 or to the device 130.

The storage system 150 generally includes components (i.e., hardware and/or software) configured to provide and manage storage resources within a computing environment, for example, the system 100. In the illustrated embodiment, the storage system 150 includes one or more advertisements 152. According to various embodiments, the one or more advertisements 152 are associated with one or more categories as explained further below in the present disclosure. As used herein, the terms “advertisement” or “advertisements” include a text message, an audio, an image, a video, and/or a combination thereof. Further, the terms “advertisement” or “advertisements” include other messages or alerts that may not be advertisements. The one or more advertisement 152 is suitable for being displayed within the vehicle 120 or on the device 130.

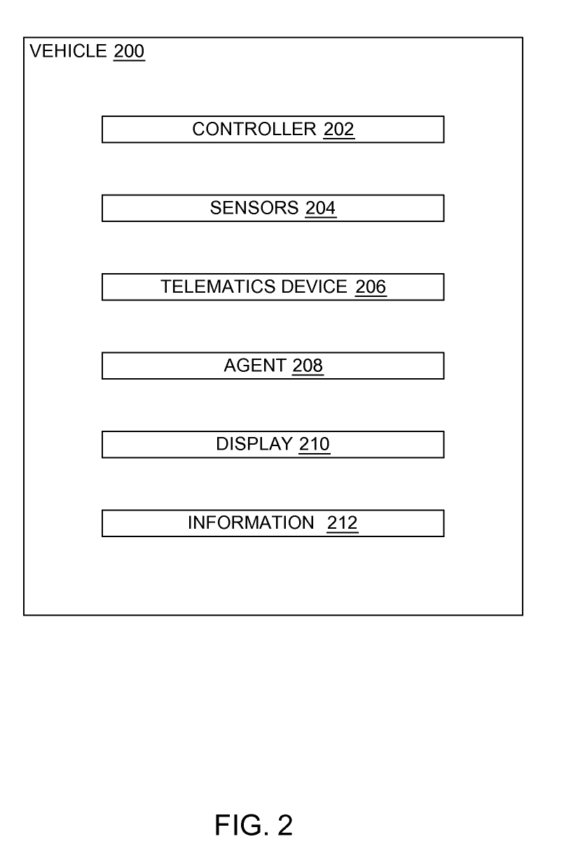

FIG. 2 illustrates a block diagram representation of an exemplary vehicle 200, according to an embodiment of the invention. The vehicle 200 includes a controller 202, sensors 204, a telematics device 206, an agent 208, a display unit 210, and information 212. The controller 202 is, in general, a computing device (e.g., a laptop, a desktop and/or the like) comprising a Central Processing Unit (CPU), various support circuits and a memory. The CPU may comprise one or more commercially available microprocessors or microcontrollers that facilitate data processing and storage. Various support circuits facilitate operation of the CPU and may include clock circuits, buses, power supplies, input/output circuits and/or the like. The memory includes a read only memory, random access memory, disk drive storage, optical storage, removable storage, and the like. It is appreciated here that the controller 202 facilitates operation and communication between various components of the vehicle 200, such as the sensors 204, the display unit 210, the agent 208 and the telematics device 206, among other functions such as processing on board data, for example.

The sensors 204 include various sensors such as sensors included in an On Board Diagnostic II (OBD II) system sensors, oil pressure sensors, tyre pressure gauge and/or the like. According to various embodiments, the sensors 204 may include other sensors, such as, low gas warning sensors, valve condition sensors to sense the condition of valves on a tank, impact sensors to measure any impact to the vehicle 120, speed sensors to measure the speed of the vehicle, accelerometers to measure the acceleration of the vehicle, and content sensors to determine the presence of material in an area, such as a cargo in the vehicle 200.

In general, the sensors 204 are configured to monitor and/or aggregate the data associated with each of the sensor 204 such as fuel usage, tire usage, engine usage, brake usage, transmission system usage among several others. In addition, other data can be determined or extracted from sensors such as maximum and minimum temperature of the engine, maximum and minimum speed, total stoppage time of the vehicle, total moving time of the vehicle, distance covered by the vehicle, average speed, high throttle, miscellaneous vehicle malfunction warnings and/or the like. The aggregated data is further combinable with other attributes of the vehicle 200 data, such as make or model of the vehicle 200. Such data pertains to the context of the vehicle 200 and is referred to as context data/information. Location information of the vehicle 200 comprises location data/information.

According to yet other embodiments, sensors 204 include sensors for capturing behavior of the user (e.g. the driver, or a passenger) of the vehicle 200 with respect to vehicle components or driving characteristics (e.g. clutch, brake, accelerator, gear shift, steering, other user operable devices in the vehicle 200). Such data pertains to the behavior of the user of the vehicle 200 and is referred to as behavior data/information. One or more of the aggregated data/information as discussed above is stored as the information 212. The information 212 may be analyzed on board the vehicle, for example, by the controller 202, or may be communicated to a server (e.g. the server 140 of FIG. 1) for analysis as described further below in the present disclosure.

The telematics device 206 is configured to communicate data to the server and/or with other devices in the system 100. According to some embodiments, the telematics device 206 is communicably coupled (e.g. wireless or wired) with one or more of the sensors 204, the controller 202, the display unit 210 and/or the agent 208. For example, in one or more embodiments, the telematics device 206 is configured to communicate with the controller 202 using wired connection or wireless connection, such as, but not limited to WiFi, or Bluetooth, or Zigbee, or a combination thereof. One example of such telematics device 206 is a VeriWise™ hub, produced by the General Electric Company.

Generally, the telematics device 206 includes a two-way data transmission system for sending and receiving various types of information. According to one or more embodiments, the telematics device 206 is utilized to determine location of the vehicle 200. For example, the telematics device 206 may communicate the information 212 to the server through a network (e.g. the network 110 of FIG. 1) to determine the location of the vehicle 200. Further, the telematics device 206 cooperates with the various sensors 204 (e.g. through the controller 202) to aggregate data/information associated with the vehicle 200. Optionally, the telematics device 206 may include a card reader (not shown) for reading or accessing magnetic cards such as credit cards, debit cards, and the like. Accordingly, the telematics device 206 may be utilized to make a transaction (e.g., purchase) subsequent to the provisioning of the one or more advertisements as described further below.

According to various embodiments, the agent 208 includes software code (e.g., processor executable instructions) that is configured to capture user actions. In one or more embodiments, the agent 208 may monitor a usage of various components (e.g., a steering, an accelerator, a brake, a window, a clutch, a gear, a display unit and/or the like) within the vehicle 200 by the user. In one embodiment, the agent 208 processes the information 212 to determine one or more user behavioral traits. For example, the agent 208 may determine that the vehicle 200 has been operating for eight hours without halts or breaks, the user responses to the steering have slowed down and/or the wheel angle response of the user has diminished. In such examples, it may be determined that the user is tired and/or sleepy. Such monitoring of the various components facilitates to classify the user behavior while driving or traveling in the vehicle. The agent 208 is further configured to communicate the information 212 to the server.

The display unit 210 is a type of display device (e.g., plasma screen, nano display screen, LCD screen and/or the like) that is capable of displaying and/or playing a text message, an image, a video, an audio and/or the like. In one embodiment, the display unit 210 is utilized to display and/or play the one or more advertisements. The display unit 210 may include various user interface elements (e.g. buttons, touch screen etc.) for user interaction. For example, the user may interact with the buttons to select the one or more advertisements to access more information displayed in that advertisement, or to perform the transaction associated with the advertisement. Once the one or more advertisements are provisioned in the vehicle 200, the user may utilize the telematics device 206 to make the transaction and purchase and/or avail offer presented in the one or more advertisements. Accordingly, the telematics device 206 may be operatively coupled to a printing device (not shown). The user may print, including but not limiting to, the one or more advertisements (e.g., a discount coupon, map to a merchant establishment and/or the like).

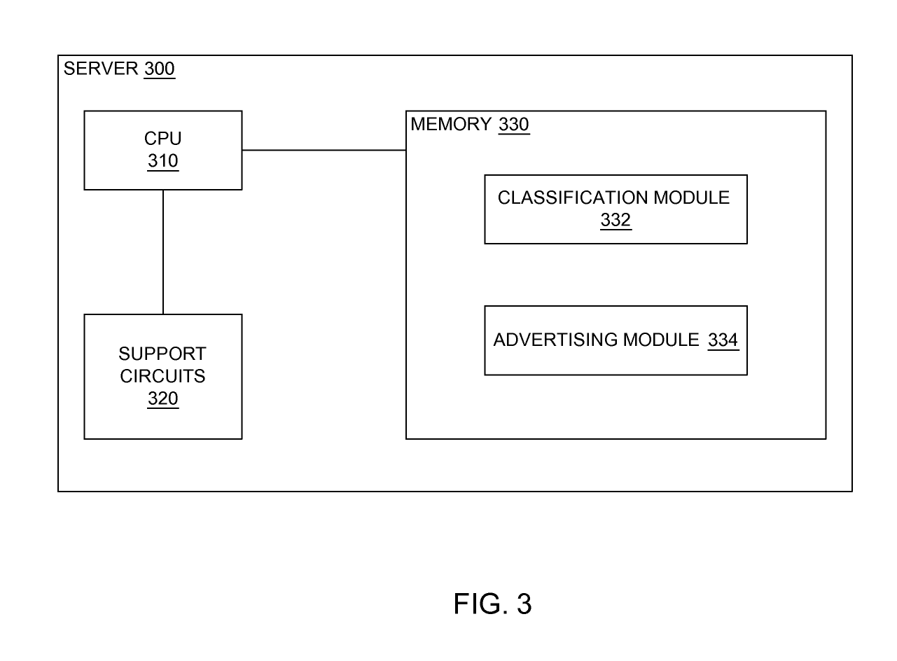

FIG. 3 is a block diagram of a server 300 (e.g. similar to server 140 of FIG. 1) for provisioning of advertisements to a vehicle (e.g. the vehicle 120 of FIG. 1 and the vehicle 200 of FIG. 2) and/or a device (e.g., the device 130 of FIG. 1) associated with a user of the vehicle 200, according to one embodiment. In one embodiment, the server 300 includes a GE Fleet management server. Accordingly, the server 300 may be utilized to process information associated with each vehicle for efficient management. Generally, the server 300 is a computing device, and the server 300 includes a Central Processing Unit (CPU) 310, support circuits 320 and a memory 330. The memory 330 includes various data and software packages, such as a classification module 332 and an advertising module 334.

The classification module 332 includes software code (e.g., processor executable instructions) that is configured to analyze information (e.g., the information 212 of FIG. 2). The classification module 332 is further configured to determine and identify one or more categories associated with user behavior traits, location of the vehicle and context of the vehicle. In one embodiment, the classification module 332 associates one or more categories such as hungry, tired, sleepy, angry, restless and/or the like to the analyzed information. Such categories are utilized by the advertising module 334 while provisioning advertisements to the vehicle user. Those skilled in the art will readily appreciate that the classification module 332 may reside with in the vehicle, and all other alternative configuration are included within the scope and spirit of the present invention.

According to various embodiments, the classification module 332 may analyze the information and determine that engine's Rounds Per Minute (RPM) exceeds a threshold value. The classification module 332 further determines that the RPM exceeds the threshold value due to input provided to an accelerator. Such an activity (i.e. input) by the user facilitates classification of the behavior.

Alternatively, the classification module 332 may determine that the RPM exceeds the threshold value due to other several reasons such as driving down a hill, gear change and/or the like. Such determination enables the classification module 332 to identify and distinguish between the behavior and the context information.

In another embodiment, the classification module 332 may analyze the information and determine that the vehicle is drifting from road due to an increased displacement angle of a steering. Further, the classification module 332 determines that the drifting of the vehicle is not due to curves, turns and/or the like on the road, but due to the aggressive change in the movement of the steering by the user. Consequently, the classification module 332 associates the user behavior with restless.

In one embodiment, the advertising module 334 includes software code (e.g., processor executable instruction) that is configured to identify the one or more advertisements that corresponds to the one or more categories. Operationally, the advertising module 334 cooperates with the classification module 332 to identify the user behavioral traits as well as the location and the context information of the vehicle. Based on the identified user behavior, the location, the context information of the vehicle and the one or more associated category, the advertising module 334 determines and identifies the one or more advertisements associated with the same category. Subsequently, the advertising module 334 compares a price associated with the each advertisement to determine advertisement associated with a highest price. Once the advertisement associated with the highest price is determines, the advertising module 334 accesses the advertisement to be provisioned to the vehicle user. However, it is appreciated here that other known ways of determining and identifying the advertisements to be provisioned to the vehicle user may be deployed, and all such techniques are included within the scope and spirit of the present invention. Non-limiting examples of such techniques include determining and identifying advertisements based on relevance and/or match of the user behavior, the location of the vehicle and/or the context of the vehicle to the advertisements and/or proximity to a point of sale, for example. Various other methods of provisioning the advertisements to the vehicle user will occur readily to those skilled in the art, and all such methods are included within the scope and spirit of the invention.

In one embodiment, the advertising module 334 communicates the one or more advertisements associated with the one or more identified categories. For example, the advertising module 334 may communicate the one or more advertisements associated with one or more hotels, restaurants, bar and/or the like, since the user is tired. It is appreciated here that although, the advertising module 334 may provision the one or more advertisements based on the user behavior, the location of the vehicle and the context of the vehicle, other combination of user behavior, location of the vehicle and the context of the vehicle such as, provisioning of the advertisements based on the user behavior and context of the vehicle, user behavior and location of the vehicle, or location of the vehicle and the content of the vehicle are also included within the scope and spirit of the invention. In one embodiment, the one or more advertisements are provisioned on a display unit (e.g., the display unit 210 of FIG. 2). In another embodiment, the one or more advertisements are provisioned on a device (e.g., the device 130 of FIG. 1).

Once the one or more advertisements are provisioned to the vehicle and/or the device, the advertising module 334 may cooperate with a telematics device (e.g., the telematics device 122 of FIG. 2 and the telematics device 206 of FIG. 2) to determine whether the user has utilized the one or more advertisements. As already discussed, the telematics device may record the one or more transactions made by the user, the advertising module 334 may charge third party vendors (e.g., advertisers) for provisioning of the one or more advertisements. In one embodiment, the third party vendors offer a price associated with each of the advertisements to be provisioned. The advertising module 334 may utilize a pay-per-impression model to charge the third party vendors and/or the like. The third party vendors and/or the like are charged a fixed price for provisioning the one or more advertisements to a fixed number of users.

Alternatively, the advertising module 334 may utilize pay-per-lead model to charge the third party vendors and/or the like. The third party vendors and/or the like are charged only when the one or more user shows interest in the one or more provisioned advertisements. For example, the user may request a print of a coupon displayed on the one or more advertisements. As such, any actions (e.g., getting directions to the advertiser's place of business, printing of a coupon, stopping outside the advertiser's place of business and/or the like) performed subsequent to the provisioning of the advertisements are monitored.

In a yet another embodiment, the advertising module 334 may utilize pay-per-sale model to charge the third party vendors and/or the like. The third party vendors and/or the like are charged only when the one or more user performs a transaction (e.g., purchase) from the vehicle. In some other embodiments, the advertising module 334 may charge the third party vendors and/or the like based on a distance and/or time for which the advertisement is provisioned.

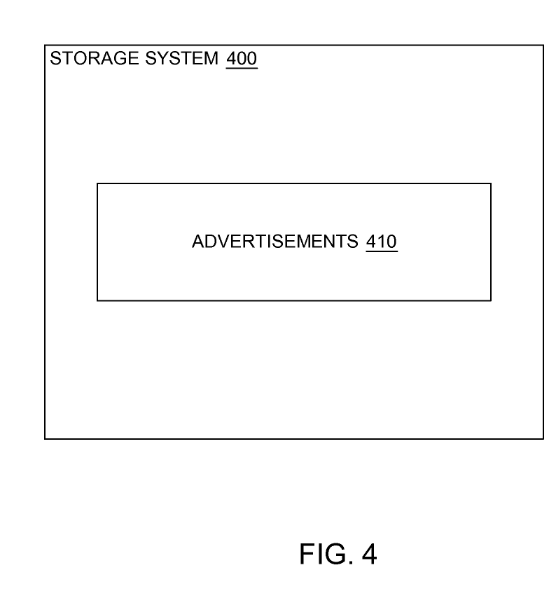

FIG. 4 is a block diagram of a storage system 400 for provisioning of advertisements according to one embodiment.

The storage system 400 generally includes various components (i.e., hardware and/or software) that are configured to manage storage resources within the computing environment. The storage 400 may include one or more data storage devices (e.g., hard disk drives, optical drives, magnetic tape drives and/or the like) and storage management software that provides an interface (e.g., Integrated Drive Electronics/AT Attachment (IDE/ATA), Small Computer Systems Interface (SCSI) and/or the like) to the one or more data storage devices for one or more computing devices, such as the server 140 of FIG. 1 and the server 300 of FIG. 3. In one embodiment, the storage system 400 includes advertisements 410.

According to one or more embodiments, the advertisements 410 are associated with one or more categories such as hungry, sleepy, tired, restless, angry and/or the like. Further, the one or more advertisements 410 may be associated with user location and context of the vehicle. Additionally, the one or more advertisements 410 are associated with various third party vendors and/or the like. The third party vendors communicates (i.e. uploads) the advertisements 410 to the storage 400 utilizing an interface, such as a Graphical User Interface (GUI). It is appreciated here that, the user may communicate the one or more advertisements 410 to the server and then the server communicates the one or more advertisements 410 to the storage 400. While communicating the advertisements 410, the third party vendor assigns one or more categories associated with the advertisements 410. In some embodiments, the third party vendors may add or generate a new category if no relevant category exists. Furthermore, while communicating the advertisements 410, the third party vendors associates a price with the each advertisement 410 that the third party vendor is willing to pay for provisioning of the advertisements 410.

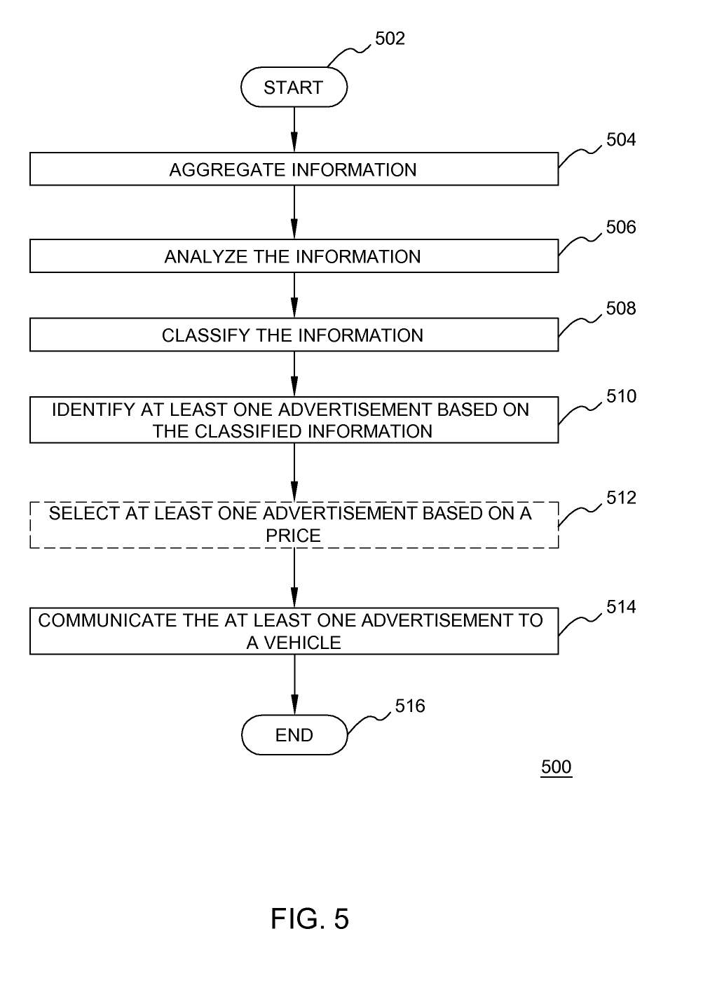

FIG. 5 is a flow diagram of a method 500 for provisioning of advertisements to a user vehicle according to one embodiment. In some embodiment, an agent (e.g., the agent 208 of FIG. 2) is executed by one or more processors to aggregate information (e.g., the information 212 of FIG. 2) associated with behavior of a user. An advertising module (e.g., the advertising module 432 of FIG. 4) accesses one or more advertisements (e.g., the advertisements 152 of FIG. 1 and the advertisements 410 of FIG. 4) to be provisioned to a vehicle (e.g., the vehicle 120 of FIG. 1 and the vehicle 200 of FIG. 2) user.

The method 500 starts at step 502 and proceed to step 504, at which information is aggregated. In some embodiments, a telematics device (e.g., the telematics device 122 of FIG. 1 and the telematics device 206 of FIG. 2) cooperates with sensors (e.g., the sensors 204 of FIG. 2) to aggregate data associated with user behavior, location of the vehicle and context of the vehicle. Such data is stored as information and is communicated to a server (e.g., the server 140 of FIG. 1 and the server 400 of FIG. 4). In one embodiment, the data is partially processed by a controller (e.g., the controller 202 of FIG. 2) before communicating to the server.

At step 506, the information is analyzed. In some embodiments, a classification module (e.g., the classification module 434 of FIG. 4) analyzes the information such that the analyzed information may be categorized into one or more categories. At step 508, the information is classified. The classification module associates one or more categories such as hungry, tired, sleepy, angry, restless and/or the like with the analyzed information. For example, the classification module may analyze the information and determine that engine's Rounds Per Minute (RPM) exceeds a threshold value. The classification module further determines that the RPM exceeds the threshold value due to input provided to an accelerator. Such an activity (i.e. input) by the user facilitates classification of the behavior.

Alternatively, the classification module may determine that the RPM exceeds the threshold value due to other several reasons such as driving down a hill, gear change and/or the like. Such determination enables the classification module to identify and distinguish between the behavior and the context information.

As another example, the classification module may analyze the information and determine that the vehicle is drifting from road due to an increased displacement angle of a steering. Further, the classification module determines that the drifting of the vehicle is not due to curves, turns and/or the like on the road, but due to the aggressive change in the movement of the steering by the user. Consequently, the classification module associates the user behavior with restless.

At step 510, one or more advertisements based on the classification information are identified. In some embodiments, the advertising module cooperates with the classification module to identify the user behavioral traits as well as the location and context information of the vehicle. Based on the identified user behavior, the location, the context information of the vehicle and the one or more associated category, the advertising module determines and identifies the one or more advertisements associated with the same category.

Optionally at step 512, at least one advertisement is selected, among the one or more advertisements, based on a price. In one embodiment, the advertising module compares a price associated with the each advertisement to determine advertisement associated with a highest price. Once the advertisement associated with the highest price is determined, the advertising module accesses the advertisement to be provisioned to the vehicle user.

According to various embodiments, the advertising module utilizes various models to charges third party vendors (e.g., advertisers) for provisioning of the one or more advertisements. The advertising module may utilize a pay-per-impression model to charge the third party vendors and/or the like. The third party vendors and/or the like are charged a fixed price for provisioning the one or more advertisements to a fixed number of users.

Alternatively, the advertising module may utilize pay-per-lead model to charge the third party vendors and/or the like. The third party vendors and/or the like are charged only when the one or more user shows interest in the one or more provisioned advertisements. For example, the user may request a print of a coupon displayed in the one or more advertisements. As such, any actions (e.g., getting directions to the advertiser's place of business, printing of a coupon, stopping outside the advertiser's place of business and/or the like) performed subsequent to the provisioning of the advertisements are monitored to determine and identify the user's interest in the one or more advertisements provisioned.

In a yet another embodiment, the advertising module may utilize pay-per-sale model to charge the third party vendors and/or the like. The third party vendors and/or the like are charged only when the one or more user performs a transaction (e.g., purchase) from the vehicle subsequent to the provisioning of the advertisements.

At step 514, the one or more advertisements are communicated to the vehicle. In one embodiment, the one or more advertisements is displayed on a display unit (e.g., the display unit 210 of FIG. 2). In an alternative embodiment, the one or more advertisements are displayed on a device (e.g., the device 130 of FIG. 1). The method 500 proceeds to step 516, where the method 500 ends.

While only certain features of the invention have been illustrated and described herein, modifications and changes will occur to those skilled in the art. It is, therefore, to be understood that the appended claims are intended to cover all such modifications and changes as fall within the true spirit of the invention.

1. A method for provisioning of advertisement to a user of a vehicle, the method comprising:
determining information comprising attributes associated with behavior of the user;
analyzing the information of the user; and
communicating at least one advertisement to the user wherein the at least one advertisement is based on the analyzed information.

2. The method of claim 1, wherein the information further comprises attributes associated with location of the vehicle.

3. The method of claim 1, wherein the information further comprises attributes associated with a context of the vehicle.

4. The method of claim 1, wherein analyzing the information of the user further comprises determining the user behavior.

5. The method of claim 1, wherein the attributes comprise usage of at least one of a steering, an accelerator, a clutch, a gear, a brake, a gear shift, a window and/or a display unit.

6. The method of claim 1, wherein the behavior comprises at least one of hungry, angry, sleepy, tired and/or restless.

7. The method of claim 3, wherein the context comprises at least one of tyre pressure, oil level, wheel angle, make of the vehicle and/or model of the vehicle.

8. The method of claim 1 further comprising displaying the at least one advertisement on the display unit in the vehicle.

9. The method of claim 1 further comprising displaying the at least one advertisement on a device accessible to the user.

10. The method of claim 1, wherein the at least one advertisement comprises at least one of text message, an audio, a video and/or an image.

11. The method of claim 1 further comprising associating a price with the at least one advertisement, wherein the price is offered by an advertiser of the at least one advertisement.

12. The method of claim 11 further comprising selecting the at least one advertisement from one or more advertisements, and wherein communicating the at least one advertisement comprises communicating the advertisement having the highest associated price from the one or more advertisements.

13. The method of claim 11, wherein the advertiser is a third party.

14. The method of claim 11, wherein the price offered by the advertisers further comprises price based on provisioning of the at least one advertisement to a fixed number of users.

15. The method of claim 11, wherein the price offered by the advertisers further comprises price based on a distance travelled by the vehicle while the advertisement is provisioned.

16. The method of claim 11, wherein the price offered by the advertisers further comprises price based on a time for which the advertisement is provisioned.

17. The method of claim 11, wherein the price offered by the advertisers further comprises price based on a number of times the advertisement is provisioned.

18. The method of claim 11, wherein the price offered by the advertisers further comprises price based on provisioning of the at least one advertisement subsequent to a user action.

19. The method of claim 11, wherein the price offered by the advertisers further comprises price based on provisioning of the at least one advertisement subsequent to a transaction performed by the user.

20. An apparatus for provisioning of advertisements to a user of a vehicle, comprising:
a telematics device to determine information comprising attributes associated with behavior of the user of the vehicle;
an agent for aggregating the information; and
an advertising module to communicate at least one advertisement to the user wherein the at least one advertisement is associated with the behavior.

21. The apparatus of claim 20, wherein the telematics device is further configured to aggregate information associated with location of the vehicle.

22. The apparatus of claim 20, wherein the telematics device is further configured to aggregate information associated with context of the vehicle.

23. The apparatus of claim 20 further comprising a display unit located within the vehicle, the display unit configured to display the at least one advertisement.

24. The apparatus of claim 20 further comprising a device accessible to the user, the device configured to display the at least one advertisement.

25. A system for provisioning of advertisements to a user of a vehicle, the system comprising:
a vehicle comprising:
a telematics device to determine information comprising attributes associated with behavior of the user of the vehicle,
an agent for aggregating the information; and
a server comprising:
a classification module for classifying the user behavior; and
an advertising module for provisioning of at least one advertisements to the vehicle, the at least one advertisement being provisioned based on the classification of user behavior.

26. The system of claim 25, wherein the telematics device is further configured to aggregate the information associated with location of the vehicle.

27. The system of claim 25, wherein the telematics device is further configured to aggregate the information associated with context of the vehicle.

28. The system of claim 25, wherein the classification module is configured to identify at least one advertisement based on the information.

29. The system of claim 25, wherein the advertising module is configured to provision the at least one advertisement on a display unit in the vehicle.

30. The system of claim 25, wherein the server further comprises displaying the at least one advertisement on a device accessible to the user.

31. A method of retrofitting a vehicle for provisioning of advertisements to a user of the vehicle, the method comprising:
providing a telematics device in the vehicle, the telematics device configured to generate and/or determine information comprising attributes associated with behavior of the user of the vehicle; and
providing an agent in the vehicle, the agent configured to aggregate the information comprising the attributes associated with the user behavior.

32. The method of claim 31 further comprises providing at least one sensor to generate the information associated with location of the vehicle.

33. The method of claim 31 further comprises providing a display unit for provisioning of the at least one advertisement.
